(19) United States
(12) Patent Application Publication
(10) Pub. No.: US 2026/0312137 A1
(43) Pub. Date: Oct. 8, 2026

(54) Method for Producing a Battery Cell and Battery Cell

(71) Applicant: Bayerische Motoren Werke Aktiengesellschaft, Muenchen (DE)

(72) Inventors: Niclas EMRICH, Muenchen (DE); Daniel PRITZL, Zachenberg (DE)

(21) Appl. No.: 19/472,147

(22) PCT Filed: Mar. 21, 2024
(86) PCT No.: PCT/DE2024/100242

§ 371 Date: Oct. 3, 2025

(30) Foreign Application Priority Data
Apr. 5, 2023 (DE) 10 2023 108 721.5

(51) Int. Cl. H01M 10/058; H01M 4/02; H01M 4/38; H01M 10/44; H01M 50/30; H01M 50/618; H01M 50/645

(52) U.S. Cl. CPC H01M 10/058; H01M 4/386; H01M 10/446; H01M 50/30; H01M 50/618; H01M 50/645; H01M 2004/027; H01M 2200/20; H01M 2220/20

(57) ABSTRACT

A method for producing a battery cell and a battery cell are disclosed. The method includes: filling a pre-assembled battery cell with an electrolyte solution via an opening in a housing of the battery cell, wherein an electrode stack consisting of a silicon-based anode, a separator, and a cathode is located in the pre-assembled battery cell; and sealing the opening of the battery cell in a gas-tight manner using a cap before carrying out a step in which the battery cell is thermally aged.

### BACKGROUND AND SUMMARY The present invention relates to a method for producing a battery cell and to a battery cell, in particular to a secondary battery cell in the form of a round cell.

The prior art discloses conventional lithium-ion battery cells that, for example, have pure graphite anodes and that are able to be sealed immediately after being filled with an electrolyte solution during a production process since, in subsequent production steps, there is only little outgassing within the battery cell.

The prior art also discloses lithium-ion battery cells having silicon-based anodes and methods for producing such lithium-ion battery cells. In comparison to conventional lithium-ion battery cells, battery cells having silicon-based anodes allow a higher volumetric energy density.

Typical production steps of such a battery cell having a silicon-based anode include, in the following order, filling a housing of the battery cell with an electrolyte solution, wherein the filling is carried out in a state in which a prefabricated electrode stack is arranged for example as a winding in a battery cell in the form of a round cell, wetting the electrode stack by way of the electrolyte solution, initial (partial) charging of the battery cell, outgassing of a carbon dioxide gas produced during charging, thermal aging, sealing the battery cell in a gas-tight manner, and one or more complete charging cycles of the battery, which may also be referred to as formation.

A considerably greater amount of carbon dioxide (for example greater by a factor of 10) is produced during the production of battery cells having silicon-based anodes than during the production of battery cells having pure graphite anodes. This is why the battery cell having silicon-based anodes is sealed at a time late in the production process in the prior art in order to ensure substantially completed outgassing of the carbon dioxide to avoid high pressures in the battery cell. At the same time, this requires the battery cell to reside in a dry room for a long time in order to prevent the ingress of harmful moisture during the unsealed processing of the battery cell.

It is an object of the present disclosure to shorten a production process for a battery cell having a silicon-based anode, as a result of which more cost-effective production of such battery cells may be achieved.

The object identified above may be achieved by the features of the independent claims. The dependent claims relate to preferred embodiments of the invention.

According to a first aspect of the present disclosure, a method for producing a battery cell is proposed, wherein the battery cell is preferably a battery cell in the form of a round cell, since the method according to the disclosure may be used particularly advantageously in conjunction with a round cell. This does not explicitly exclude the method according to the disclosure from also being able to be used advantageously with another form factor such as a prismatic battery cell or the like.

The battery cell is particularly advantageously a battery cell of a traction battery for a vehicle, wherein the traction battery is preferably constructed from a plurality of battery cells that are produced according to the disclosure and that are connected in series and/or in parallel. By way of example, the vehicle may be a road vehicle (for example motorcycle, automobile, van, truck) or a rail vehicle or an airplane/aircraft and/or a watercraft.

In a first step of the method according to the disclosure, a preassembled battery cell is filled with an electrolyte solution via an opening in a housing of the battery cell (dosing), wherein an electrode stack comprising a silicon-based anode, a separator and a cathode is arranged in the preassembled battery cell. The silicon-based anode is in particular a graphite anode that has a proportion by weight of silicon that is preferably between 2% and 20%. In such a silicon-based anode, lithium is incorporated during the production of the battery cell and can be found in the cathode. In this case, the term “electrode stack” is intended to be understood to mean merely a layering of the anode and the cathode with the separator in between, and not necessarily a multiply folded stack of the electrodes, as is used in prismatic cells, for example. Accordingly, it is possible for the electrode stack to be preprocessed in the form of a winding (as is advantageously used in round cells; this is also referred to as a jelly roll), or as a multiply folded stack or in a form differing from this.

It should additionally be noted that steps, which precede the step described above, of producing the electrode stack, of introducing the electrode stack into the housing and of electrically contact-connecting the electrode stack to the outside of the battery are not described in more detail since these are known from the prior art, and therefore reference is made to the prior art in this regard.

Furthermore, it should be noted that production steps, which follow the filling, in the present description are described on the basis of a preferred order of production steps, wherein wetting (soaking) of the electrode stack is carried out after the filling of the battery cell. There is an initial (partial) charging (pre-charging) of the battery cell after the wetting. Thermal aging (temperature aging) of the battery cell is carried out after the initial (partial) charging, and formation, in which the activation of the battery cell is completed by multiple charging and discharging operations, is carried out after the thermal aging. It should be explicitly noted that the method according to the disclosure is not restricted to the above preferred order. It should be further noted that a second step of the method that will be described below may be positioned at different points in the order described above.

In the second step of the method according to the disclosure, the opening of the battery cell is sealed in a gas-tight manner by way of a cap before the execution of a production step of thermally aging the battery cell. By way of example, the gas-tight sealing may be effected with a material bond (for example by welding) and/or with a force fit and/or with a form fit. Thermal aging is also known as temperature aging and it is used, amongst other things, to form what is known as the SEI (solid electrolyte interphase) on the anode. The thermal aging of a battery cell sealed according to the disclosure is carried out, for example, by applying a temperature to the battery cell of between 20° C. and 50° C., and preferably of between 25° C. and 45° C., for a period of time of, for example, 20 h to 55 h, and preferably from 24 h to 48 h. In the installed state, the cap preferably simultaneously constitutes an electrical pole of the battery that may be electrically contact-connected from outside of the battery cell. In such a case, the cap is also referred to as a “terminal.”

In contrast, in the prior art, the battery cell is sealed after the execution of the step of thermal aging, with the result that carbon dioxide gas formed in the process may escape from the battery cell. In the prior art, a typical temperature for the thermal aging is, for example, approximately 45° C., wherein, in the prior art, this temperature acts on the battery cell for up to 48 h, for example.

Since battery cells according to the prior art and according to the present disclosure are preferably processed in a dry room in order to avoid the ingress of moisture up until the time at which sealing takes place, which generally entails high costs, any shortening of a required passage time through the dry room results in a corresponding cost saving.

Accordingly, a shortening of the passage time through the dry room may be achieved by sealing the battery cell earlier in comparison to the prior art, as a result of which a corresponding reduction in the production costs is achieved. In addition, the production process is shortened overall, which also results in a cost reduction.

The early sealing is possible, since test series carried out by the inventors have surprisingly shown that an increased internal pressure of the battery cell associated with early sealing does not cause any significant changes with respect to the service life and/or the dimensional stability, etc., even when a conventional battery cell design is used. Should an internal pressure of the battery cell that is increased according to the disclosure have, for example, an adverse effect on the dimensional stability and/or impermeability of the battery cell, it is possible, for example, to insert a reinforced housing wall and/or a material and/or a material combination with an increased pressure resistance for the housing and/or a seal, which is adapted to the higher pressure, between the housing and the cap. By way of example, the housing wall is formed of steel (preferably with a nickel plating) and preferably has a thickness of at least 0.4 mm, further preferably of at least 0.5 mm, even more preferably of at least 0.6 mm, and in particular preferably of at least 0.7 mm.

Furthermore, tests known from the prior art have shown that carbon dioxide dissolved in an electrolyte solution may lead to an advantageous regeneration of the SEI interface, as a result of which a service life and/or a performance capability of a battery cell may be increased. Since the early sealing, according to the disclosure, of the battery cell is intentionally carried out before the outgassing of the carbon dioxide has been substantially completed, which is conventional in the prior art, a correspondingly greater residual amount of carbon dioxide, both in gaseous and dissolved form, is present, as a result of which it may be assumed that the above-described advantageous effect of the regeneration of the SEI interface may additionally be achieved.

Depending on a selection of the time at which the battery cell is sealed, a further advantage of the method according to the disclosure may result to the effect that a dry room is possibly not needed if there is a sufficiently short period of time (for example up to a few seconds or up to a few minutes) between the time at which filling takes place and the time at which sealing takes place, during which there may be no significant ingress of moisture from the ambient air into the electrolyte solution,.

As a result of early sealing of the battery cell, it is also possible to dispense with a collecting device, which collects an electrolyte solution that may escape during the processing, and which may be arranged at the opening of the battery cell during production.

In one advantageous configuration of the method, the gas-tight sealing of the battery cell may be executed before or during a step of initially charging (pre-charging), in particular of initially partially charging or pre-charging, the battery cell. The initial charging is a production step that follows a wetting step, which is described in more detail below, as described at the outset. The initial charging, which may possibly be interrupted by the step of sealing, is advantageously carried out up to a state of charge of 5% to 50%, preferably of 20% to 40%, and in particular preferably up to 30%, without being restricted to the above values. By way of example, the initial charging is carried out at an ambient temperature of approximately 25° C. and for an exemplary duration of approximately 3 h. Since the step of initially charging the battery cell is executed chronologically before the step of thermal aging, sealing the battery cell before or during the initial charging correspondingly results in a further advantageous shortening of the production process of the battery cell and in particular in a further reduction in a passage time through a dry room.

In a further advantageous configuration of the present disclosure, the gas-tight sealing of the battery cell may be executed before or during a step of wetting (soaking) the electrode stack with the electrolyte solution. As described at the outset, the wetting is a step, which follows the filling of the battery cell, in which the electrolyte solution is absorbed into the electrode stack. By way of example, the wetting may be carried out at a temperature of approximately 45° C. at an ambient pressure of 1 bar to 2 bar and for an exemplary duration of approximately 18 h, without imposing a restriction in this regard by the above exemplary values. By virtue of the sealing being carried out before or during the wetting, it is accordingly possible to achieve a further advantageous shortening of the production process of the battery cell. In particular if the sealing is executed before or at the beginning of the wetting phase, the battery cell may possibly be processed without being brought into a dry room, since the electrolyte is exposed to an air humidity only for a short period of time following the filling.

A time for sealing the opening of the battery cell may be particularly advantageously set in such a way that there is a minimum pressure of 1.2 bar, preferably of 1.5 bar, and further preferably of 2 bar, in the finished battery cell under predefined reference conditions. By way of example, the predefined reference conditions correspond to a room temperature of approximately 21° C., a state of charge of the battery cell of approximately 5%, and a quiescent state of the battery cell, that is to say a state in which there is no current flow between the battery cell and an area surrounding the battery cell. The time at which sealing takes place, on the basis of which the above pressure conditions are able to be achieved, may be ascertained experimentally and/or by simulation, for example, wherein in particular information relating to a cell chemistry used, the design of the battery cell, in particular of the housing, the electrode stack, etc., may be included in such a simulation.

Further advantageously, a time for sealing the opening may be set in such a way that a proportion of a carbon dioxide dissolved in the finished battery cell in relation to a total amount of carbon dioxide (i.e. comprising dissolved and free carbon dioxide) contained in the finished battery cell under predefined reference conditions is between 40% and 95%, preferably between 60% and 80%, and further preferably between 70% and 75%. The predefined reference conditions advantageously correspond to the reference conditions mentioned above. In addition, the time at which sealing takes place may also be ascertained experimentally and/or by way of a simulation as described above.

Particularly preferably, the time at which sealing takes place may be ascertained on the basis of a measurement of an internal pressure of the battery cell by virtue of a pressure measuring device being arranged at the opening of the battery cell that has not yet been sealed, for example. The time for sealing the battery cell, which results from a pressure measurement, may for example be ascertained during a development phase for a respective battery cell, and so the time ascertained in this way may be used during subsequent series manufacture of the battery cell without carrying out renewed individual pressure measurements for the battery cells to be manufactured in each case. Alternatively or additionally, it is also conceivable to measure a current pressure of some or all of the battery cells involved in the series manufacture in order to individually determine respective times for sealing the respective battery cells.

In a further advantageous configuration of the present disclosure, the battery cell may be sealed in a gas-tight manner in an atmosphere in which there is a reduced pressure in relation to the atmospheric pressure. By way of example, an ambient pressure of at most 0.8 bar, of at most 0.5 bar, or of at most 0.2 bar is produced in this case. Furthermore, it is possible to execute the sealing in a vacuum, for example. The effect that may be achieved by this is that an internal pressure, which is present after production, of the battery is reduced despite increased outgassing.

Further advantageously, the battery cell may be exposed to an ambient air with a relative air humidity of at least 10%, preferably of at least 20%, and further preferably of at least 30%, from a time at which the battery cell is filled with the electrolyte solution to a time at which the battery cell is sealed. That is to say that a correspondingly higher air humidity may be permitted due to the early sealing of the battery cell, since, in comparison to the prior art, the electrolyte solution is exposed to the air humidity from the ambient air for a shorter duration.

According to a second aspect of the present disclosure, a battery cell is proposed, which has a housing with an opening, an electrolyte solution, an electrode stack comprising a silicon-based anode, a separator and a cathode, a cap, and an overpressure valve, wherein the electrode stack is arranged within the housing. The battery cell is designed to be filled with the electrolyte solution via the opening of the housing and to be sealed in a gas-tight manner using the cap by way of a step of sealing the opening before the execution of a step of thermally aging the battery cell. The overpressure valve is designed to reduce a pressure within the battery cell as soon as the pressure within the battery cell exceeds a value of 1.5 bar, preferably of 2 bar, and further preferably of 3 bar.

Further details, features and advantages of the invention will become apparent from the description below and the figures.

### BRIEF DESCRIPTION OF THE DRAWINGS

FIG. 1 shows a flowchart illustrating steps of an exemplary embodiment of a method according to the disclosure; and

FIG. 2 shows a schematic view of a battery cell according to the disclosure.

### DETAILED DESCRIPTION OF THE DRAWINGS

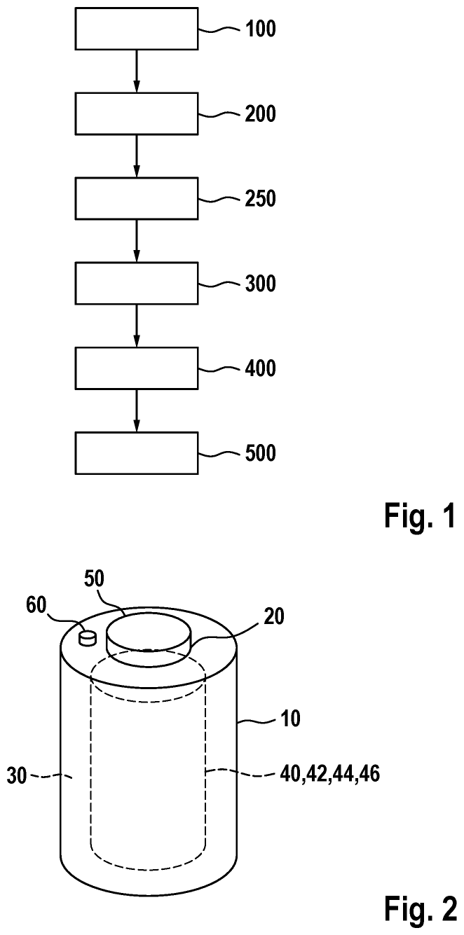

FIG. 1 shows a flowchart illustrating steps of an exemplary embodiment of a method according to the disclosure.

In step 100 of the method according to the disclosure, a preassembled battery cell in the form of a round cell is filled with an electrolyte solution via an opening in a housing of the battery cell. An electrode stack comprising a silicon-based anode, a separator and a cathode is arranged in the preassembled battery cell. The filling is carried out here in a dry atmosphere that is provided in a dry room. The filling is carried out at a pressure of between 3 bar and 6 bar and at a temperature of 45° C.

In step 200, wetting of the electrode stack is carried out at an ambient pressure of 1 bar to 2 bar and a temperature of approximately 45° C. For this purpose, the battery cell stays in the dry room in order to protect the electrolyte solution from the ingress of moisture. A period of time of approximately 18 h is provided for the wetting in this case.

Following the wetting, the opening of the battery cell is sealed in a gas-tight manner in step 250. The sealing is carried out by way of a cap and a sealing element that is arranged between the cap and the housing of the battery cell. Immediately after the sealing of the battery cell, the latter is removed from the dry room in order to keep a passage time inside the dry room, which entails high costs, as short as possible.

In step 300, initial charging of the battery cell is then carried out at a temperature of 25° C., wherein the battery cell is charged to 30% of its charging capacity over a period of time of approximately 3 h.

In step 400, thermal aging of the battery cell is then carried out for approximately 24 h at a temperature of 25° C.

In the final step 500, which represents a formation step, the battery cell is fully charged multiple times in alternation with the battery cell being discharged in order to complete activation of the battery cell.

FIG. 2 shows a schematic view of a battery cell according to the disclosure.

The battery cell has a housing 10 with an opening 20, an electrolyte solution 30, an electrode stack 40 comprising a silicon-based anode 42, a separator 44 and a cathode 46, a cap 50, and an overpressure valve 60.

The electrode stack 40 is arranged within the housing 10, wherein electrical contact-connection of the electrode stack 40 to the outside of the battery is not shown in this case.

In the course of a production process of the battery cell, the electrolyte solution 30 has been filled in via the opening 20 of the battery cell in order to completely wet the electrode stack 40 with the electrolyte solution 30.

The cap 50, which in this case is simultaneously used as an electrical contact-connection in the form of what is known as a “terminal,” has, in the course of the battery cell being produced, been arranged and fixed in the region of the opening 20 such that the opening 20 is sealed in a gas-tight manner by the cap 50. The gas-tight seal may be ensured by a sealing element introduced between the cap 50 and the housing 10 of the battery cell.

In this case, the battery cell is sealed by way of the cap 50 immediately following an initial charging phase (pre-charging) of the battery cell and therefore before execution of a thermal aging of the battery cell. This makes it possible to shorten a production process of the battery cell according to the disclosure in comparison to a production process from the prior art.

The overpressure valve 60 is provided on account of an outgassing of carbon dioxide gas that takes place during the thermal aging, the overpressure valve ensuring that an internal pressure of the battery cell in the sealed state does not exceed a value of 2 bar.

### LIST OF REFERENCE SIGNS

10 Housing
20 Opening
30 Electrolyte solution
40 Electrode stack
42 Anode
44 Separator
46 Cathode
50 Cap
60 Overpressure valve

1-12. (canceled)

13. A method for producing a battery cell, of the method comprising:
filling a preassembled battery cell with an electrolyte solution via an opening in a housing of the battery cell, the electrode stack comprising a silicon-based anode, a separator and a cathode and being arranged in the preassembled battery cell;
sealing the opening of the battery cell utilizing a cap to form a gas-tight seal; and
after forming the gas-tight seal, thermally aging the battery cell.

14. The method according to claim 13, wherein the silicon-based anode comprises a graphite anode having a proportion by weight of silicon that is between 2% and 20%.

15. The method according to claim 13, wherein sealing the opening is carried out before or during an initial charging of the battery cell.

16. The method according to claim 15, wherein the initial charging includes only partial charging of the battery cell.

17. The method according to claim 13, wherein sealing the opening is carried out before or during wetting of the electrode stack with the electrolyte solution.

18. The method according to claim 13, wherein a time for sealing the opening is set in such a way that there is a pressure of at least 1.2 bar in a finished battery cell under predefined reference conditions.

19. The method according to claim 18, wherein the pressure in the finished battery cell is at least 1.5 bar.

20. The method according to claim 19, wherein the pressure in the finished battery cell is at least 2 bar.

21. The method according to claim 18, wherein the predefined reference conditions correspond to a room temperature of 21° C., a state of charge of the battery cell of 5%, and a quiescent state of the battery cell, wherein the quiescent state of the battery cell represents a state in which there is no current flow between the battery cell and an area surrounding the battery cell.

22. The method according to claim 13, wherein a time for sealing the opening is set in such a way that a proportion of carbon dioxide dissolved in a finished battery cell in relation to a total amount of carbon dioxide contained in the finished battery cell under predefined reference conditions is between 40% and 95%.

23. The method according to claim 22, wherein the proportion is between 60% and 80%.

24. The method according to claim 23, wherein the proportion is between 70% and 75%.

25. The method according to claim 22, wherein the predefined reference conditions correspond to a room temperature of 21 C., a state of charge of the battery cell of 5%, and a quiescent state of the battery cell, wherein the quiescent state of the battery cell represents a state in which there is no current flow between the battery cell and an area surrounding the battery cell.

26. The method according to claim 13, wherein a time at which the sealing takes place is ascertained on the basis of a measurement of an internal pressure of the battery cell.

27. The method according to claim 13, wherein the gas-tight seal is formed in an atmosphere in which there is a reduced pressure compared to atmospheric pressure.

28. The method according to claim 13, wherein the battery cell is exposed to ambient air with a relative air humidity of at least 10% from a time at which the battery cell is filled with the electrolyte solution to a time at which the battery cell is sealed.

29. The method according to claim 28, wherein the relative air humidity is at least 20%.

30. The method according to claim 29, wherein the relative air humidity is at least 30%.

31. The method according to claim 13, wherein the battery cell is a battery cell of a traction battery for a vehicle.

32. A battery cell comprising:
a housing with an opening;
an electrolyte solution;
an electrode stack comprising a silicon-based anode, a separator and a cathode;
a cap; and
an overpressure valve;
wherein
the electrode stack is arranged within the housing,
the battery cell is configured to be filled with the electrolyte solution via the opening of the housing and to be sealed in a gas-tight manner by the cap via a step of sealing the opening before thermally aging the battery cell, and
the overpressure valve is designed to reduce a pressure within the battery cell as soon as the pressure within the battery cell exceeds a value of 1.5 bar.
